(19) United States
(12) Patent Application Publication
(10) Pub. No.: US 2020/0393156 A1
(43) Pub. Date: Dec. 17, 2020

(54) TEMPERATURE ADJUSTMENT FEEDBACK SYSTEM IN RESPONSE TO USER INPUT

(71) Applicant: Alibaba Group Holding Limited, George Town (KY)

(72) Inventors: Jin Ryong Kim, San Jose, CA (US); Chen Zhao, San Jose, CA (US); Limin Paul Fu, San Jose, CA (US); Jonas C. Kong, San Jose, CA (US); Stephanie Chan, Sunnyvale, CA (US); Michael Lee, Palo Alto, CA (US); Kenneth Ng, San Jose, CA (US)

(21) Appl. No.: 16/681,629

(22) Filed: Nov. 12, 2019

Related U.S. Application Data
(60) Provisional application No. 62/860,687, filed on Jun. 12, 2019.

(51) Int. Cl. F24F 11/52; G06T 19/00; G06F 3/01; F24F 11/56

(52) U.S. Cl. CPC F24F 11/52; G06T 19/003; F24F 2120/20; F24F 11/56; G06F 3/017

(57) ABSTRACT

A temperature adjustment feedback system in response to user input is disclosed, including: receiving a user input with respect to a virtual object; updating the virtual object based at least in part on the user input; determining temperature adjustment based at least in part on the user input; and outputting the temperature adjustment.

### CROSS REFERENCE TO OTHER APPLICATIONS

This application claims priority to U.S. Provisional Patent Application No. 62/860,687 (Attorney Docket No. ALIBP411+) entitled MID-AIR THERMAL FEEDBACK SYSTEM FOR 3D INTERACTION filed Jun. 12, 2019 which is incorporated herein by reference for all purposes.

### BACKGROUND OF THE INVENTION

Typically, to physically experience a product, a person must go to a brick-and-mortar store to test the item out. However, it is not always convenient or practical to travel to a physical store to try out a product. A person may remotely interact with a product by browsing photos at a website, for example, but such an experience is not immersive nor does it approximate physically using the product.

### BRIEF DESCRIPTION OF THE DRAWINGS

Various embodiments of the invention are disclosed in the following detailed description and the accompanying drawings.

FIG. 1A is a diagram showing an embodiment of a system for providing a mid-air temperature adjustment output in response to a user input.

FIG. 1B is a functional diagram illustrating an embodiment of a main computer for providing temperature adjustment in response to a user input.

FIG. 2 is a diagram showing an example of a mid-air temperature adjustment device.

FIG. 3 is a diagram showing an example of a system for providing a mid-air temperature adjustment output in response to a user input.

FIG. 4 is a flow diagram showing an embodiment of a process for providing a mid-air temperature adjustment output in response to a user input.

FIG. 5 is a flow diagram showing an embodiment of a process for providing a mid-air temperature adjustment output in response to a user input.

FIG. 6 is a flow diagram showing an example of a process for providing a mid-air temperature adjustment output in response to a user input.

FIGS. 7A and 7B describe examples of a 3D virtual object being displayed by a system for providing a mid-air temperature adjustment output in response to a user input.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of providing a mid-air temperature adjustment output in response to a user input are described herein. A user input is received with respect to a virtual object. In some embodiments, the virtual object is a three-dimensional (3D) object that is rendered and presented by an autostereoscopic display such that the virtual object appears as a 3D hologram. In some embodiments, the user input does not require the user to make physical contact with a physical object, and is detected using a sensor device. For example, the user input may be a hand movement, a foot movement, a head movement, and/or an eye movement. In some embodiments, it is determined that the user input affects the virtual object because a collision is detected between user input and the virtual object in 3D space. A mid-air temperature adjustment is determined based at least in part on the user input. In various embodiments, a “mid-air temperature adjustment” comprises a temperature adjustment (e.g., heat, cold, and/or air) that is able to be sensed (e.g., by a user) without direct/physical contact with a physical object (e.g., the source of the temperature adjustment). In some embodiments, the temperature adjustment is determined based at least in part on a measurement that is determined based on the user input in relation to at least a portion of the virtual object in 3D space. The mid-air temperature adjustment is output. For example, the mid-air temperature adjustment feedback comprises heat that is blown in the direction of the user's hand from at least one mid-air temperature adjustment device. In some embodiments, also in response to the user input, the appearance of the virtual object is updated. In some embodiments, also in response to the user input, feedback other than a mid-air temperature adjustment is provided such as, for example, haptic feedback.

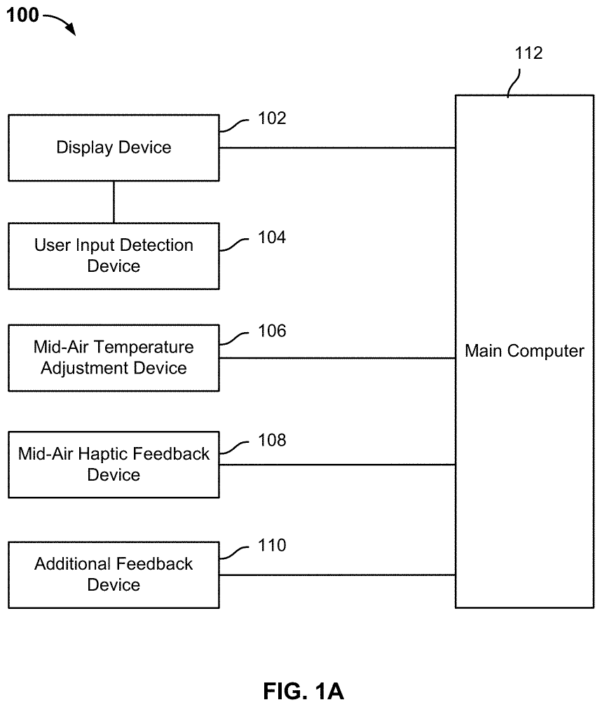

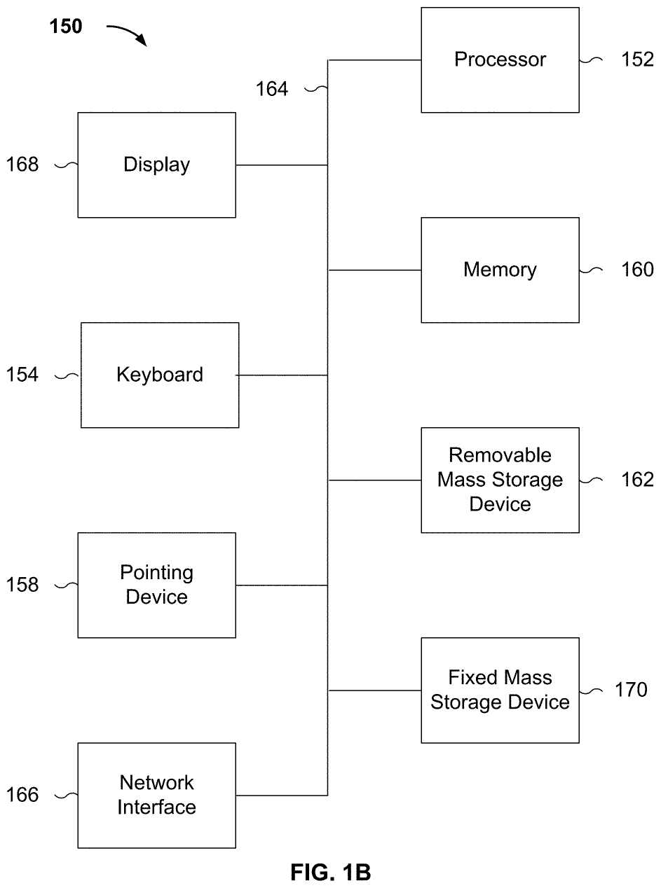

FIG. 1A is a diagram showing an embodiment of a system for providing a mid-air temperature adjustment output in response to a user input. In the example, system 100 includes main computer 112, display device 102, user input detection device 104, mid-air temperature adjustment device 106, mid-air haptic feedback device 108, and additional feedback device 110. As shown in FIG. 1A, each of display device 102, mid-air haptic feedback device 108, mid-air temperature adjustment device 106, and additional feedback device 110 is connected to main computer 112. Also, as such in FIG. 1A, user input detection device 104 is connected to display device 102. In some other embodiments, user input detection device 104 may be connected directly to main computer 112 and not display device 102. In some embodiments, one or more of display device 102, user input detection device 104, mid-air temperature adjustment device 106, mid-air haptic feedback device 108, and additional feedback device 110 include a corresponding driver that interfaces with it and another device to which it communicates.

Main computer 112 is configured to execute a software environment (e.g., a game engine) that is configured to render 3D virtual objects in 3D space. For example, the software environment is a Unity game engine. Files/information usable to render 3D virtual objects may be stored locally at main computer 112 or obtained via a network (not shown) from a remote server (not shown). In some embodiments, the 3D virtual objects that are rendered by main computer 112 comprise products. In some embodiments, the 3D virtual objects that are rendered by main computer 112 are animated, at least in part. For example, a 3D virtual object may comprise a showerhead that is emitting animations of water streams. Main computer 112 is configured to output at least one 3D virtual object to display device 102.

Display device 102 is configured to present a 3D virtual object. In some embodiments, display device 102 is configured to present the 3D virtual object as a 3D hologram. In various embodiments, display device 102 is an autostereoscopic display device (e.g., a device that is manufactured by Seefront™ or Dimenco™), a virtual reality display device, or a device that displays images that give the perception of 3D depth without the use of special headgear or glasses on the part of the viewing user.

User input detection device 104 includes one or more sensors that track user inputs/movements. For example, user input detection device 104 is configured to track eye movements, hand movements, leg/foot movements, and/or head movements. In response to each detected movement, user input detection device 104 is configured to send a corresponding message to display device 102, which may in turn send a corresponding message to main computer 112. Based on the message of the detected user input, the software environment that is executing at main computer 112 is configured to determine whether the user input has collided with at least a portion of a 3D virtual object that is presented at display device 102 and if so, update the appearance of that 3D virtual object accordingly and/or cause a mid-air feedback to be output by mid-air temperature adjustment device 106, mid-air haptic feedback device 108, and/or other feedback device 110. In some embodiments, a user input is determined to have “collided” with at least a portion of a 3D virtual object when the point(s) in 3D space in which the user input is detected overlaps with the volume in 3D space that is defined for the 3D virtual object. Put another way, a user gesture interaction that is sensed by user input detection device 104 may cause main computer 112 to generate an updated appearance to a 3D virtual display that is presented by display device 102 and/or cause a mid-air feedback that is output by at least one peripheral feedback device (e.g., mid-air temperature adjustment device 106, mid-air haptic feedback device 108, and/or additional feedback device 110).

For example, main computer 112 may render multiple 3D virtual objects comprising products that are downloaded from a remote server that is associated with an online shopping platform. Main computer 112 is configured to send the rendered multiple 3D virtual objects to display device 102, where the 3D virtual products are presented as 3D holograms. User gestures with respect to 3D virtual products are tracked by user input detection device 104. A particular detected user gesture that is detected by user input detection device 104 is determined by main computer 112 to match a predetermined user gesture that is associated with selecting a particular 3D virtual product. In response to the detected predetermined selection user gesture, the software environment executing at main computer 112 is configured to cause the selected 3D virtual product to be presented at display device 102 and to be interacted with via user inputs. In a specific example, the initially presented 3D virtual products comprise 3D showerheads and/or faucets and the specific item that is selected is a particular model of a showerhead. Once the showerhead is selected, the user may continue to interact with just the selected showerhead via user input in a way that allows for an immersive mid-air sensory-based experience, as will be described below.

Mid-air temperature adjustment device 106 is configured to receive an instruction from main computer 112 to output a temperature adjustment feedback. In various embodiments, mid-air temperature adjustment device 106 comprises a heating component and a fan. In some embodiments, mid-air temperature adjustment device 106 comprises a heating component, a cooling component, and a fan. In some embodiments, mid-air temperature adjustment device 106 is instructed by main computer 112 to activate the fan to produce a cool breeze, thereby reducing the temperature within the vicinity of system 100 and/or to cause a sensation of wind against a user (e.g., the user's hand). In some embodiments, mid-air temperature adjustment device 106 is configured to activate a heating component (e.g., a positive temperature coefficient (PTC)) to produce heat, thereby increasing the temperature within the vicinity of system 100. In some embodiments, mid-air temperature adjustment device 106 is configured to activate a cooling component (e.g., a thermoelectric cooler) to produce a chill, thereby decreasing the temperature within the vicinity of system 100. In some embodiments, mid-air temperature adjustment device 106 is configured to activate the fan in conjunction with at least one of the heating component and the cooling component to distribute the heat and/or the chill in a particular direction away from mid-air temperature adjustment device 106 and towards the user. In some embodiments, the degree (e.g., temperature) of the temperature adjustment (e.g., heat or cold) that is produced by mid-air temperature adjustment device 106 is determined and instructed by main computer 112. In some embodiments, the intensity and/or speed of the wind that is produced by mid-air temperature adjustment device 106 is determined and instructed by main computer 112.

When the mid-air temperature adjustment feedback is perceived by a user, the user may sense warmth or cool as if they are in proximity or even in direct contact with the source of the temperature adjustment. In some embodiments, mid-air temperature adjustment device 106 is configured to output a temperature adjusting feedback in response to a user interaction/input with respect to a 3D virtual object that is presented by display device 102. For example, if the user interacts with a presented 3D virtual object in a manner that would allow the user to experience heat emanating from the 3D virtual object, mid-air temperature adjustment device 106 is configured to activate its heating component and also its fan to transfer heat towards the user, as if the heat were emanating from the 3D virtual object.

While only one instance of mid-air temperature adjustment device 106 is shown in system 100, multiple instances of mid-air temperature adjustment device 106 may be connected to main computer 112. For example, each instance of mid-air temperature adjustment device 106 may be arranged in a different location (e.g., relative to another peripheral of main computer 112, such as display device 102 and mid-air haptic feedback device 108) to provide temperature adjustment feedback from a different position/location. For example, multiple instances of mid-air temperature adjustment device 106 can provide different temperature feedback with respect to their respectively different positions/locations. In some embodiments, main computer 112 may select all instances of mid-air temperature adjustment device 106 or only a subset of the instances of mid-air temperature adjustment device 106 to output a temperature adjusting feedback depending on factors such as, for example, the location of a user (e.g., the location of the user's palm, which is more sensitive to detecting wind and/or temperature changes as compared to the back of the hand) and/or the orientation of the selected 3D virtual object with which the user is currently interacting.

Mid-air haptic feedback device 108 is configured to receive an instruction from main computer 112 to output a haptic feedback. Haptics (or haptic) is the science and engineering of applying touch sensation in a computer system. In some embodiments, mid-air haptics comprises non-contact haptic feedback that a user perceives in mid-air. There are several types of mid-air haptic feedback devices including, for example, ultrasonic vibration using a two-dimensional (2D) array of ultrasound transducers, laser-based tactile feedback, and air vortex using an actuated flexible nozzle with subwoofers. In various embodiments, mid-air haptic feedback device 108 is configured to emit ultrasound waves to create a tactile sensation at one or more focal points. For example, the focal points of the ultrasound waves in 3D space correspond to the detected location of a user's hand, thereby causing the user to perceive tactile feedback. In some embodiments, the degree (e.g., pressure) and/or locations of haptic feedback that are produced by mid-air haptic feedback device 108 are determined and instructed by main computer 112.

When the mid-air haptic feedback is perceived by a user, the user may sense pressure if they were in direct contact with a physical object. In some embodiments, mid-air haptic feedback device 108 is configured to output haptic feedback in response to a user interaction/input with respect to a 3D virtual object that is presented by display device 102. In one example, if the user browses through multiple 3D virtual objects or a 3D environment/scene (e.g., a menu), mid-air haptic feedback device 108 is configured to output haptic feedback that allows the user to perceive that they are physically moving items or making selections (e.g., of a particular 3D virtual object). In another example, if the user interacts with a presented 3D virtual object in a manner that would allow the user to touch the 3D virtual object, mid-air haptic feedback device 108 is configured to output a haptic feedback to cause the user to perceive that his or her hand(s) are touching the object.

While only one instance of mid-air haptic feedback device 108 is shown in system 100, multiple instances of mid-air haptic feedback device 108 may be connected to main computer 112. For example, each instance of mid-air haptic feedback device 108 may be arranged in a different location (e.g., relative to another peripheral of main computer 112, such as display device 102 and mid-air temperature adjustment device 106) to provide haptic feedback from a different position/location. In some embodiments, main computer 112 may select all instances of mid-air haptic feedback device 108 or only a subset of the instances of mid-air haptic feedback device 108 to output a haptic feedback depending on factors such as, for example, the location of a user (e.g., the location of the user's palm, which is more sensitive to detecting wind and/or temperature changes as compared to the back of the hand) and/or the orientation of the selected 3D virtual object with which the user is currently interacting.

In embodiments, main computer 112 is configured to cause both mid-air temperature adjustment device 106 and mid-air haptic feedback device 108 to simultaneously output feedback to cause the user to perceive that he or she is touching or in contact with a tangible item that provides either cool or warmth without ever physically coming in contact with a physical item or a heat/cold source. Returning to the example described above in which a user has selected a 3D virtual object comprising a showerhead to further interact with, display device 102 is configured to enlarge the presentation of or otherwise make more conspicuous the 3D virtual showerhead such that the user can virtually try it with more ease. For example, the user may use his or her hands to cause the 3D hologram of the showerhead to spray water and the 3D hologram of the showerhead would be updated to show that water is spraying from the 3D virtual showerhead in a way that approximates how a physical version of the same showerhead would. For example, the user's hand motions will be tracked by user input detection device 104 and eventually input to main computer 112. In the event that the software environment executing at main computer 112 determines that the user input had matched a predetermined user gesture associated with causing the 3D virtual showerhead to spray water (such as turning the palm in a certain direction), the software environment is configured to update the appearance of the 3D virtual showerhead by causing display device 102 to additionally present animation of water spraying out of the showerhead. For example, the user may interact with the 3D virtual showerhead and the animated water streams to both alter the shape of the water streams and also trigger both temperature adjustment feedback and haptic feedback to be output, such that the user's hands can sense pressure and warmth from the water spraying from the 3D virtual showerhead. In another example, if the 3D virtual object includes both a 3D virtual showerhead and a 3D virtual bathtub faucet, then both the 3D virtual showerhead and the 3D virtual bathtub faucet may simultaneously spray water with which the user can interact. For example, the user's hand motions will be tracked by user input detection device 104 and eventually input to main computer 112. In the event that the software environment executing at main computer 112 determines that the user input had collided with the animation of the spraying water from the 3D virtual showerhead and/or 3D virtual bathtub faucet in 3D space, the software environment is configured to update the appearance of the 3D virtual showerhead and/or 3D virtual bathtub faucet by causing display device 102 to display an altered animation of water spraying out of the showerhead and/or bathtub faucet in which the water streams are deformed due to their collisions with the user's hand. Furthermore, in the event that the software environment executing at main computer 112 determines that the user input had collided with the animation of the spraying water from the 3D virtual showerhead and/or 3D virtual bathtub faucet in 3D space, main computer 112 is configured to send instructions to mid-air temperature adjustment device 106 to cause mid-air temperature adjustment device 106 to generate heat and activate the fan to distribute the heat and to send instructions to mid-air haptic feedback device 108 to cause mid-air haptic feedback device 108 to generate haptics at focal points that correspond to the location of the user's hand in 3D space. As a result of the temperature adjustment and haptic feedbacks, the user may experience an immersive simulated try-out of water spraying from a selected showerhead without needing to directly engage or even touch a physical item. In the event that multiple instances of mid-air temperature adjustment device 106 and mid-air haptic feedback device 108 are used, main computer 112 may send different signals to each instance of a device to cause a different feedback to be emitted by that instance of the device. For example, if the 3D virtual objects could simultaneously produce both hot water and cold water from different spouts, then main computer 112 could send one set of signals to cause one instance of mid-air temperature adjustment device 106 to emit hot air and main computer 112 could send another set of signals to cause another instance of mid-air temperature adjustment device 106 to emit cold air.

Additional feedback device 110 is configured to provide an additional feedback that is other than haptic or temperature-based. In one example, additional feedback device 110 comprises a speaker that is configured to provide an audio-based feedback. In another example, additional feedback device 110 is configured to provide a scent or a fragrance-based feedback. In response to user input that is tracked by user input detection device 104 and that is forwarded to main computer 112, in some embodiments, main computer 112 is configured to determine whether the user input and/or the 3D virtual object that is currently presented by display device 102 is to trigger an audio and/or fragrance-based feedback.

FIG. 1B is a functional diagram illustrating an embodiment of a main computer for providing temperature adjustment in response to a user input. As will be apparent, other computer system architectures and configurations can be used to provide temperature adjustment in response to a user input. In some embodiments, main computer 112 of system 100 of FIG. 1A may be implemented using computer system 150. Computer system 150, which includes various subsystems as described below, includes at least one microprocessor subsystem (also referred to as a processor or a central processing unit (CPU)) 152. For example, processor 152 can be implemented by a single-chip processor or by multiple processors. In some embodiments, processor 152 is a general purpose digital processor that controls the operation of the computer system 150. Using instructions retrieved from memory 160, the processor 152 controls the reception and manipulation of input data, and the output and display of data on output devices (e.g., display 168).

Processor 152 is coupled bi-directionally with memory 160, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 152. Also as is well known in the art, primary storage typically includes basic operating instructions, program code, data, and objects used by the processor 152 to perform its functions (e.g., programmed instructions). For example, memory 160 can include any suitable computer readable storage media, described below, depending on whether, for example, data access needs to be bi-directional or uni-directional. For example, processor 152 can also directly and very rapidly retrieve and store frequently needed data in a cache memory (not shown).

A removable mass storage device 162 provides additional data storage capacity for the computer system 150 and is coupled either bi-directionally (read/write) or uni-directionally (read only) to processor 152. For example, storage 162 can also include computer readable media such as magnetic tape, flash memory, PC-CARDS, portable mass storage devices, holographic storage devices, and other storage devices. A fixed mass storage 170 can also, for example, provide additional data storage capacity. The most common example of fixed mass storage 170 is a hard disk drive. Mass storages 162, 170 generally store additional programming instructions, data, and the like that typically are not in active use by the processor 152. It will be appreciated that the information retained within mass storages 162 and 170 can be incorporated, if needed, in standard fashion as part of memory 160 (e.g., RAM) as virtual memory.

In addition to providing processor 152 access to storage subsystems, bus 164 can also be used to provide access to other subsystems and devices. As shown, these can include a display 168, a network interface 166, a keyboard 154, and a pointing device 158, as well as an auxiliary input/output device interface, a sound card, speakers, and other subsystems as needed. For example, the pointing device 158 can be a mouse, stylus, track ball, or tablet, and is useful for interacting with a graphical user interface.

The network interface 166 allows processor 152 to be coupled to another computer, computer network, or telecommunications network using a network connection as shown. For example, through the network interface 166, the processor 152 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 152 can be used to connect the computer system 150 to an external network and transfer data according to standard protocols. For example, various process embodiments disclosed herein can be executed on processor 152, or can be performed across a network such as the Internet, intranet networks, or local area networks, in conjunction with a remote processor that shares a portion of the processing. Additional mass storage devices (not shown) can also be connected to processor 152 through network interface 166.

An auxiliary I/O device interface (not shown) can be used in conjunction with computer system 150. The auxiliary I/O device interface can include general and customized interfaces that allow the processor 152 to send and, more typically, receive data from other devices such as microphones, touch-sensitive displays, transducer card readers, tape readers, voice or handwriting recognizers, biometrics readers, cameras, portable mass storage devices, and other computers.

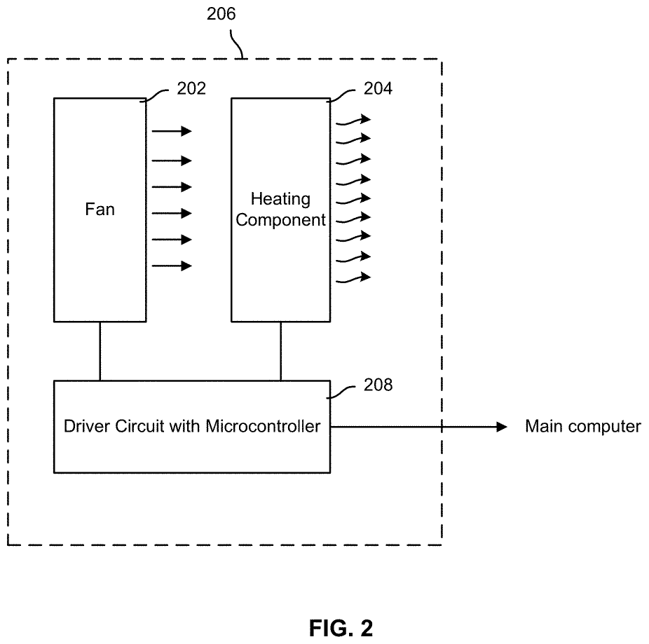

FIG. 2 is a diagram showing an example of a mid-air temperature adjustment device. In some embodiments, mid-air temperature adjustment device 106 of system 100 of FIG. 1A is implemented using mid-air temperature adjustment device 206 of FIG. 2.

As shown in FIG. 2, mid-air temperature adjustment device 206 comprises fan 202 and heating component 204, e.g., Positive Temperature Coefficient (PTC), which are each connected to driver circuit with microcontroller 208. Driver circuit with microcontroller 208 is in turn connected to a main computer (e.g., main computer 112 of system 100 of FIG. 1A). Driver circuit with microcontroller 208 is configured to interface with the main computer. For example, instructions from the main computer are received at driver circuit with microcontroller 208 and driver circuit with microcontroller 208 is configured to send corresponding respective instructions to one or both of fan 202 and heating component 204. In some embodiments, fan 202 and heating component 204 may be instructed to be activated at different times. For example, heating component 204 may be instructed to be activated (e.g., turned on) when a particular selection is made by a user with respect to a user input detection device that is connected to the main computer. For example, heating component 204 can be activated in anticipation of a subsequent output of a temperature adjustment feedback because heating component 204 cannot produce heat instantaneously. Therefore, sometime after heating component 204 is activated, driver circuit with microcontroller 208 receives instructions from the main computer to activate fan 202. Because heating component 204 had been activated earlier and has already produced heat, subsequently activating fan 202 will cause the heat to be distributed/transferred away from mid-air temperature adjustment device 206.

The following is an example process by which mid-air temperature adjustment device 206 is configured to generate a temperature adjustment: When driver circuit with microcontroller 208 receives an activation signal from the main computer, it may activate heating component 204 and/or fan 202 at the same time or at a later time, depending on the type of activation signal. When driver circuit with microcontroller 208 receives a deactivation signal from the main computer, it may deactivate both heating component 204 and/or fan 202, depending on the type of deactivation signal. The main computer can send the activation signal only to fan 202 in case the heated air needs to be cooled down. In some embodiments, the main computer contains a timer to keep track of how long heating component 204 has been turned on and sends a deactivate signal once the timer expires (e.g., to prevent heating component 204 from overheating). For example, the timer is (e.g., user) configured to start at a certain value (e.g., 10) and starts counting down when heating component 204 starts generating heat. Once the timer reaches zero, the main computer sends a deactivation signal to driver circuit with microcontroller 208 to cause both heating component 204 and fan 202 to deactivate.

In some embodiments, driver circuit with microcontroller 208 is configured to receive an instruction associated with a specified degree and/or intensity at which either or both of fan 202 or heating component 204 is to operate. Driver circuit with microcontroller 208 is configured to translate the specified degree and/or intensity into a corresponding computer instruction that is configured to cause corresponding either or both of fan 202 or heating component 204 to operate accordingly and to send the corresponding computer instruction to either or both of fan 202 or heating component 204.

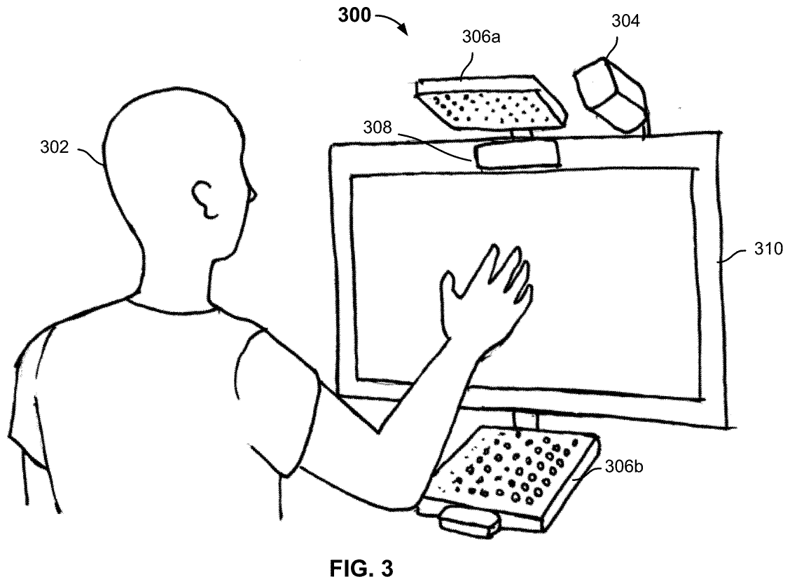

FIG. 3 is a diagram showing an example of a system for providing a mid-air temperature adjustment output in response to a user input. In the example of FIG. 3, system 300 includes display device 310, motion detection device 308, mid-air haptic feedback device 306a, mid-air haptic feedback device 306b, mid-air temperature adjustment device 304, and a main computer (not shown). While not shown in FIG. 3, the main computer is connected to, receives inputs from, and sends instructions to each of display device 310, motion detection device 308, mid-air haptic feedback device 306a, mid-air haptic feedback device 306b, and mid-air temperature adjustment device 304.

In this example, display device 310 comprises an autostereoscopic display that presents 3D holograms of objects to user 302, who does not need to wear dedicated glasses to experience the 3D depths of the holograms. In other embodiments, virtual reality displays that require special glasses, goggles, or other equipment can be used. The virtual objects that are presented by display device 310 are rendered by a software environment (e.g., game engine) executing at the main computer. For example, a virtual object comprises two stereoscopic images that can be displayed in autostereoscopic 3D display. Motion detection device 308 is built into display device 310 and is configured to track user motions, including, for example, eye and/or hand motions. Motion detection device 308 is configured to track the position and pose of user 302's hand. Mid-air haptic feedback device 306a is placed in front of and above display device 310 and mid-air haptic feedback device 306b is placed in front of and below display device 310 to respectively provide tactile feedback from the top and the bottom to user 302 to be matched with the binocular illusion (e.g., of a 3D virtual object) that is presented in mid-air. In FIG. 3, each mid-air haptic feedback device 306a and 306b comprises an ultrasound haptic device that comprises a 2D array of multiple transducers and these transducers create focused ultrasonic vibrations so user 302 can feel the tactile sensations when the hand is placed near it. As shown in FIG. 3, mid-air temperature adjustment device 304 is placed besides mid-air haptic feedback device 306a to provide heated air in conjunction with (or independent of) haptics feedback. For example, mid-air temperature adjustment device 304 is angled between 30 to 45 degrees, facing towards the focal points of mid-air haptic feedback device 306a. While not shown in FIG. 3, a corresponding mid-air temperature adjustment device may also be placed next to mid-air haptic feedback device 306b. When either mid-air haptic feedback device 306a or 306b is activated to generate focused haptic feedback, in some embodiments, heated air is also produced by a corresponding mid-air temperature adjustment device to provide a temperature adjustment feedback that could be sensed by a user's palm, for example, as user 302 interacts with the 3D object that is presented by display device 310. For example, haptic and/or temperature adjustment feedback may be output from either mid-air haptic feedback device 306a and mid-air temperature adjustment device 304 or mid-air haptic feedback device 306b and a corresponding mid-air temperature adjustment device depending on the predicted current location of user 302's palm and/or the orientation of a 3D virtual object that is presented by display device 310.

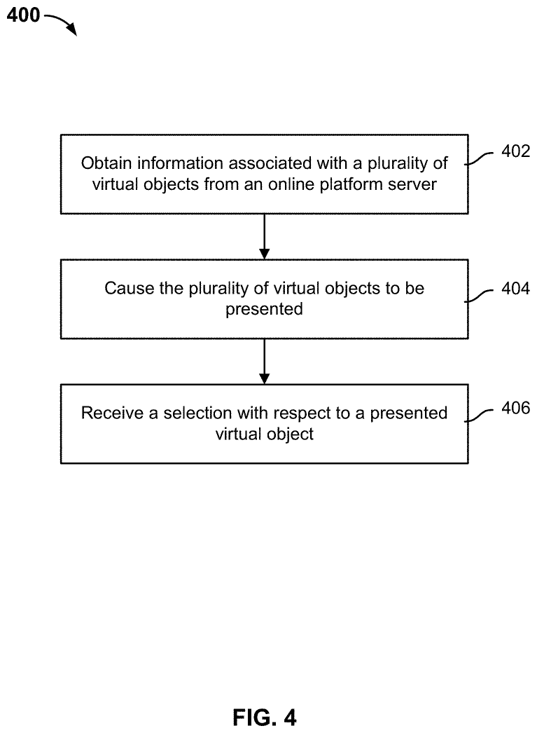

FIG. 4 is a flow diagram showing an embodiment of a process for providing a mid-air temperature adjustment output in response to a user input. In some embodiments, process 400 may be implemented at system 100 of FIG. 1A.

At 402, information associated with a plurality of virtual objects is obtained from an online platform server. In some embodiments, information corresponding to virtual objects that correspond to new products is obtained from a server associated with an online shopping platform. For example, information associated with a virtual object includes images that are usable to render a 3D hologram of a corresponding new physical product that is for sale at the online shopping platform. Information associated with a virtual object also comprises descriptions of the features and/specifications of a new product to which the virtual object corresponds.

At 404, the plurality of virtual objects is caused to be presented. The virtual objects are presented as 3D holograms at a display device that the user can browse through via user inputs (e.g., hand motions). For example, user interactions with the presented 3D virtual objects may allow a cursor to highlight any one of the 3D virtual objects.

At 406, a selection with respect to a presented virtual object is received. In some embodiments, a user selection gesture (e.g., the action of a user making a pushing motion with his or her hand) for selecting a particular presented 3D virtual object is determined. If the predetermined user selection gesture is detected with respect to the 3D virtual object that the cursor is currently highlighting, then the 3D virtual object is selected for further interaction. In some embodiments, if no 3D virtual object is detected within a predetermined length of time since the cursor has been highlighting a 3D virtual object, that 3D virtual object is automatically selected (e.g., in anticipation of the user's potential interest in the 3D virtual object and/or the system's potential failure to detect the predetermined user selection gesture that the user had attempted to perform).

One example application of a mid-air temperature adjustment output in response to a user input is a holographic signage kiosk setup to showcase virtual products. Users can interact with the virtual products using mid-air gestures and motions, as well as eye movements, and receive simulated warmth or cold to their hand as their hand collides with the 3D virtual objects in different ways.

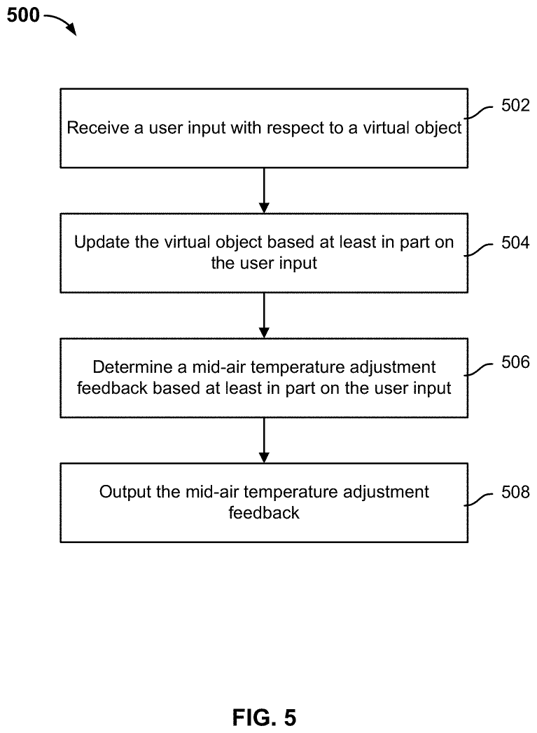

FIG. 5 is a flow diagram showing an embodiment of a process for providing a mid-air temperature adjustment output in response to a user input. In some embodiments, process 500 may be implemented at system 100 of FIG. 1A.

At 502, a user input with respect to a virtual object is received. A user input comprises a user motion, such as, for example, an eye motion, a hand motion, a leg motion, a foot motion, and/or a head motion. In some embodiments, the virtual object is presented at a display. For example, the virtual object is one that was selected by the user during a process such as process 400 of FIG. 4. For example, the display comprises an autostereoscopic display. In various embodiments, the user input is determined to be related to the virtual object in the event that it is determined that the location of the user input has collided with (e.g., is within the collision area of) the virtual object in 3D space.

At 504, the virtual object is updated based at least in part on the user input. In some embodiments, the appearance of the virtual object is updated based on the user input. For example, depending on the location of the user input relative to the location (e.g., collision area) of the virtual object in 3D space, the shape and/or associated animation of the virtual object is updated and the updated virtual object is presented. For example, the user input may have deformed the at least portion of the virtual object because the virtual object is configured to be compressible (e.g., the virtual object is a sofa cushion). In another example, the user input may have changed the associated animation of the virtual object (e.g., the virtual object comprises a showerhead with an animation of spraying water that is coming out of the showerhead).

At 506, a mid-air temperature adjustment feedback is determined based at least in part on the user input. A corresponding mid-air temperature adjustment feedback comprising of at least air and one of warmth or cold is determined based on the user input. For example, a corresponding mid-air temperature adjustment feedback is generated depending on the location of the user input relative to the location of at least a portion of the virtual object in 3D space.

At 508, the mid-air temperature adjustment feedback is output. The corresponding mid-air temperature adjustment feedback is output towards the direction of the user input and/or the current location of the user. In some embodiments, the corresponding mid-air temperature adjustment feedback is output in conjunction with another mid-air feedback (e.g., haptic feedback) that is also determined based on the user input.

An example application for providing temperature adjustment feedback in response to a user input is in the area of shopping in which users may want to interact with virtual products before they purchase physical versions of the products. Users can check out not only the product details but also the features that the products can provide. For example, users may want to try and feel the pressure of the new water jet feature of a newly released luxurious jetted bathtub. In another example, users may also want to try and feel the different types of hot waterfall settings of a new shower head product. By applying the temperature adjustment feedback system in accordance with some embodiments described herein, a user can interact with the feature of 3D virtual products and receive multi-sensory feedback to experience a more realistic and intuitive simulation of engaging with the products.

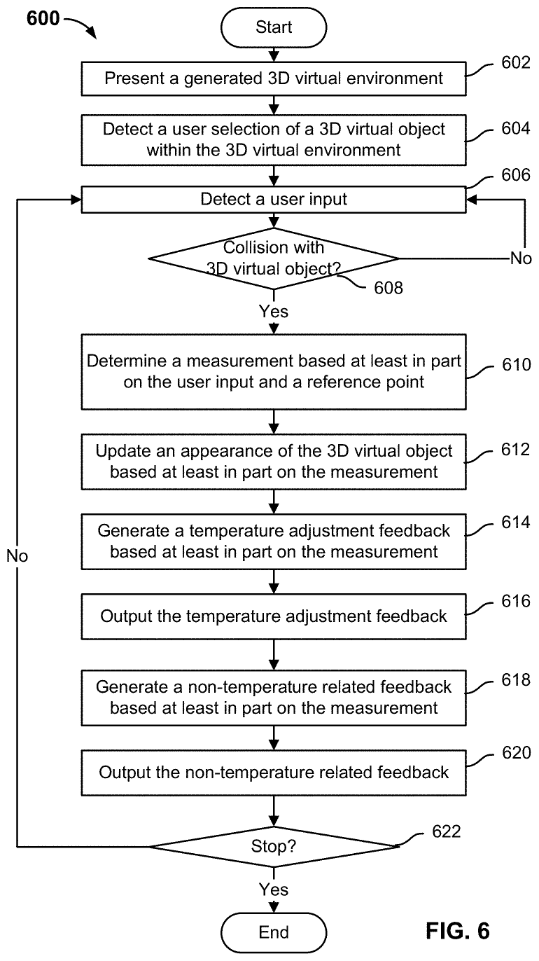

FIG. 6 is a flow diagram showing an example of a process for providing a mid-air temperature adjustment output in response to a user input. In some embodiments, process 600 may be implemented at system 100 of FIG. 1A. In some embodiments, process 400 of FIG. 4 may be implemented at least in part by process 600. In some embodiments, process 500 of FIG. 5 may be implemented at least in part by process 600.

At 602, a generated 3D virtual environment is presented. The 3D virtual environment comprises a 3D virtual scene. In some embodiments, one or more 3D virtual objects are presented within the 3D virtual environment. The 3D virtual environment and/or the 3D virtual objects are presented by a (e.g., autostereoscopic) display device. In some embodiments, the 3D virtual environment and/or the 3D virtual objects are created using a game engine such as, for example, Unity. For example, the 3D virtual scene comprises a bathroom and the 3D virtual objects within the scene are different bathroom appliances (e.g., a bathtub, a showerhead, and/or a toilet).

At 604, a user selection of a 3D virtual object is detected within the 3D virtual environment. A particular 3D virtual object is selected by a user based on, for example, a detected user input that matches a predetermined selection gesture. The selected 3D virtual object may be enlarged in the presentation by the display device such that its features may be more visible to the user.

In some embodiments, the 3D virtual object comprises an animation. For example, the 3D virtual object is a combination of a bathroom accessory and a stream of liquid (e.g., water) that is emitting from the accessory. Specifically, the 3D virtual object comprises a flow of water coming out of a faucet, a showerhead, or a nozzle. In some embodiments, the 3D virtual object is animated. For example, if the 3D virtual object were a flow of water, the animation is of the water constantly spraying out of a source (e.g., a faucet, a showerhead, or a nozzle).

At 606, a user input is detected. A user's (e.g., hand, eye, head, foot, and/or leg) motion/input is detected by a motion detection device. In some embodiments, one or more points in 3D space that are associated with the user input are determined. For example, a coordinate associated with the location of the user's hand in 3D space is determined.

At 608, it is determined whether the user input collided with the 3D virtual object. In the event that the user input had collided with the 3D virtual object, control is transferred to 610. Otherwise, in the event that the user input had not collided with the 3D virtual object, control is returned to 606 to wait for a user input.

In some embodiments, to determine whether the user input collided with the 3D virtual object, the point(s) in 3D space that is associated with the user input is associated with the collision area of the 3D virtual object. For example, the collision area of the 3D virtual object may be defined as a portion of the 3D virtual object or the entire volume of the 3D virtual object. For example, if the coordinate associated with the location of the user's hand in 3D space overlaps with any of the defined collision area of the 3D virtual object, then it is determined that there is a collision between the user input and the 3D virtual object. However, if the coordinate associated with the location of the user's hand in 3D space does not overlap with any of the defined collision area of the 3D virtual object, then it is determined that there is not collision between the user input and the 3D virtual object and the next user input is waited to be detected at step 606.

At 610, a measurement determined based at least in part on the user input and a reference point is determined. In some embodiments, a reference point is defined as a portion of the 3D virtual object. In some embodiments, a reference point is defined as the location of the motion detection device. For example, a distance may be computed between the location of the user input and the reference point in 3D space.

At 612, an appearance of the 3D virtual object is updated based at least in part on the measurement. In some embodiments, the 3D virtual object may be updated by changing its shape and/or animation. For example, if the detected user's hand moved closer to the reference point of a 3D virtual object comprising the source of a flow of water, the distance between the source of the flow of water and the user's hand would decrease and the 3D virtual object may be shown to be a shorter stream of water that appears to be compressed. In another example, depending on the location of the user's hand, the flow of water may be shown to both collide with an object (the user's hand) and also flow around the object.

At 614, a temperature adjustment feedback is generated based at least in part on the measurement. In some embodiments, the temperature adjustment feedback can be updated by turning on the heating component, changing the temperature of the heating component, turning on the fan, and/or a combination of the above. Because the heating component of a temperature adjustment feedback device cannot instantaneously produce heat (e.g., heat may take two to three seconds to be produced), it can be turned on prior to a detected collision between a user input and the 3D virtual object in anticipation of such a collision. For example, when a user selects to interact with a 3D virtual object for which thermal feedback is provided or even when the 3D virtual environment is first presented (e.g., steps 604 or 602, respective), the heating component of the temperature adjustment feedback device can be turned on. For example, later, when a collision between a user's hand and the 3D virtual object is detected, the fan portion of the temperature adjustment feedback device can be turned on to direct the generated heat towards the location of the user's hand (e.g., palm) to simulate a warm (or other temperature adjusting) feedback that is provided by the user's engagement with the 3D virtual object.

At 616, the temperature adjustment feedback is output. If multiple temperature adjustment feedback devices are used, then temperature adjustment feedback can be provided by a combination of the temperature adjustment feedback devices depending on the location of the user's hand (e.g., palm).

At 618, a non-temperature related feedback is generated based at least in part on the measurement.

At 620, the non-temperature related feedback is output.

In some embodiments, a mid-air haptic feedback can be updated by changing the intensity/pressure and/or area of mid-air focal position. For example, if the user's hand is to be closer to the source of a 3D virtual object comprising a flow of water, then the haptic feedback would provide greater pressure on the user's hand (e.g., palm) than if the user's hand is farther away from the source of the flow of water. Also, for example, if the user's hand is to be closer to the reference point of a 3D virtual object comprising the source of a flow of water, then the mid-air haptic feedback would provide a pressure to a smaller contact area on the user's hand (e.g., palm) than if the user's hand had been further away from the source of the flow of water. If multiple mid-air haptic feedback systems are used, then haptic feedback can be provided by a combination of the haptic feedback systems depending on the location of the user's hand (e.g., palm).

In some embodiments, an audio feedback can be updated by playing various recorded audio data and/or at different volumes depending on the location of the user's hand.

In some embodiments, a scent-based feedback can be updated by emitting various scents depending on a detected user input and/or the type of product that is associated with the selected 3D virtual object.

In some embodiments, a non-temperature related feedback is coordinated with temperature adjustment feedback such that the user can perceive the multiple feedbacks together. For example, a mid-air haptic feedback may be output from a mid-air haptic feedback device in the same direction and at least partially simultaneously as a mid-air temperature adjusting feedback is output from a mid-air temperature adjusting device. In a specific example, if a user performs a user input with respect to a 3D showerhead object that is spraying water, mid-air heat and mid-air haptic feedback (in addition to audio feedback) may be output towards the location of the user's palm so that the user can experience a simulated sensation of warm water contacting his or her palm.

In some embodiments, the type of updating to the 3D virtual object and/or the type of feedback that is generated by the one or more feedback devices is determined based on predetermined mappings between the current location of the user's hand and corresponding updates and/or feedback rules. In some embodiments, the type of updating to the 3D virtual object and/or the type of feedback that is generated by the one or more feedback devices is dynamically determined based on physics-based simulations. For example, the type of updating to the 3D virtual object includes how the shape and animation of the 3D virtual object is to change given different user inputs. For example, the types of feedback that is generated by the one or more feedback devices include the length, temperature, intensity, volume, and/or direction of the output by each of the feedback devices (e.g., a mid-air temperature adjustment feedback device, a mid-air haptic feedback device).

At 622, it is determined whether a mid-air temperature adjustment output is to be continued to be provided. In the event that mid-air temperature adjustment output is to be continued to be provided, control is returned to 606. Otherwise, in the event that mid-air temperature adjustment output is to no longer continue to be provided, process 600 ends.

For example, mid-air temperature adjustment output is no longer to be provided in the event that the system on which process 600 is implemented is turned off and/or loses power.

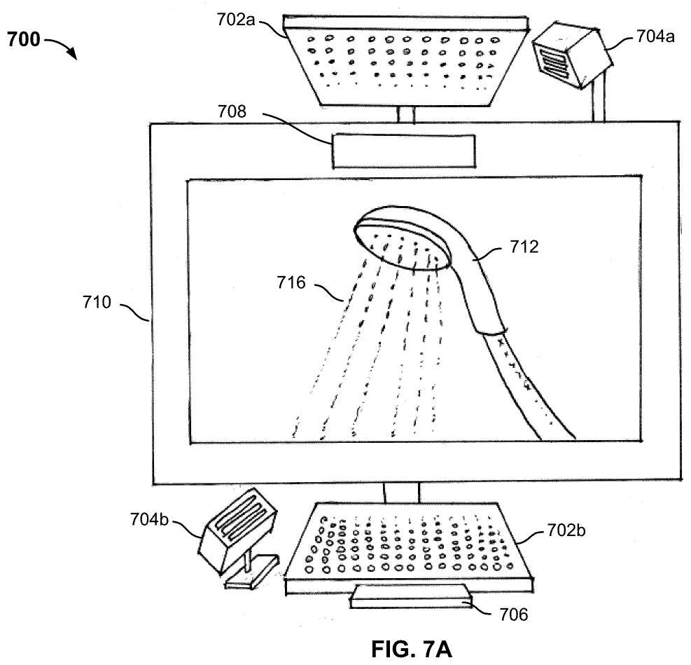

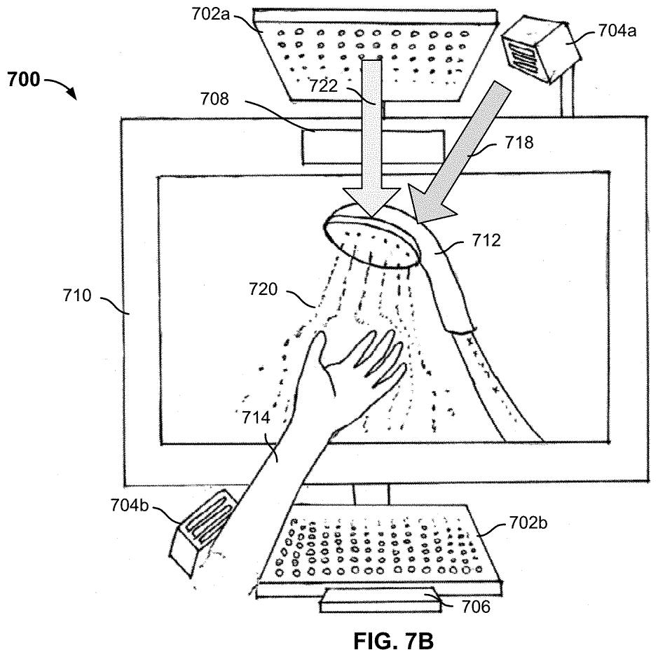

FIGS. 7A and 7B describe examples of a 3D virtual object being displayed by a system for providing a mid-air temperature adjustment output in response to a user input. In the examples of FIGS. 7A and 7B, system 700 includes display device 710, eye motion detection device 708, hand motion detection device 706, mid-air haptic feedback device 702a, mid-air haptic feedback device 702b, mid-air temperature adjustment device 704a, mid-air temperature adjustment device 704b, and a main computer (not shown). In the example of system 700, eye motion detection device 708 is embedded in display device 710 but hand motion detection device 706 is not embedded in display device 710 and instead, arranged adjacent to mid-air haptic feedback device 702b. As shown in FIGS. 7A and 7B, mid-air haptic feedback device 702a and mid-air temperature adjustment device 704a are placed above display device 710 and mid-air haptic feedback device 702b and mid-air temperature adjustment device 704b are placed below display device 710. Depending on where the user input is detected (e.g., relative to at least one of eye motion detection device 708 and hand motion detection device 706) and/or the orientation of 3D virtual showerhead 712, feedback can be provided by a different combination of mid-air haptic feedback device 702a, mid-air haptic feedback device 702b, mid-air temperature adjustment device 704a, and mid-air temperature adjustment device 704b. While not shown in FIGS. 7A and 7B, the main computer is connected to, receives inputs from, and sends instructions to each of display device 710, eye motion detection device 708, hand motion detection device 706, mid-air haptic feedback device 702a, mid-air haptic feedback device 702b, mid-air temperature adjustment device 704a, and mid-air temperature adjustment device 704b.

In the example of FIG. 7A, display device 710, which is an autostereoscopic display, is displaying 3D virtual showerhead 712. For example, 3D virtual showerhead 712 was selected by a user to be displayed from a menu that was previously presented at display device 710. In a specific example, a virtual bathroom scene was previously presented at display device 710 and a user had selected 3D virtual showerhead 712 to interact with the features of that model of showerhead. 3D virtual showerhead 712 includes animation of a water stream 716 from the showerhead. For example, animation of a water stream 716 of 3D virtual showerhead 712 may be modeled based on how water actually sprays out of a physical showerhead on which 3D virtual showerhead 712 is based. As shown in FIG. 7A, absent any user interaction with 3D virtual showerhead 712, animation of a water stream 716 flows uninterrupted as it does not collide with any object. As will be described with FIG. 7B, below, a user input (e.g., hand gesture and/or eye moment) that is detected by system 700 may cause 3D virtual showerhead 712 to be presented differently and/or cause system 700 to output feedback via at least one feedback device (e.g., mid-air haptic feedback device 702a, mid-air haptic feedback device 702b, mid-air temperature adjustment device 704a, and mid-air temperature adjustment device 704b).

In the example of FIG. 7B, user hand 714 is placed “under” 3D virtual showerhead 712 to “touch” the animated water that is coming out from 3D virtual showerhead 712. The gesture and location of user hand 714 (in the 3D space in which 3D virtual showerhead 712 exists) are detected by hand motion detection device 706 (and, in some embodiments, the eye movements of the user are detected by eye motion detection device 708). For example, the current location of user hand 714 is detected to collide with the defined collision area of 3D virtual showerhead 712 and its accompanying water animation. As such, a measurement of length/distance is computed by the main computer between the current location of user hand 714 and the location of hand motion detection device 706 (or a reference point on 3D virtual showerhead 712, such as the center of 3D virtual showerhead 712's face). The measured length/distance is used by the main computer to cause the water spraying out of 3D virtual showerhead 712, animation of a water stream 720, to appear as if the water stream has collided with an object (user hand 714) and is now shown to be deformed and flowing around the detected object (user hand 714) rather than flowing as if uninterrupted, as it had been shown in FIG. 7A.

Furthermore, the measured length/distance is used by the main computer to cause haptic feedback 722 to be provided downward toward user hand 714 by mid-air haptic feedback device 702a and also heated air feedback 718 to be provided down towards user hand 714 by mid-air temperature adjustment device 704a. The focal position of (e.g., ultrasound) haptic feedback 722 is determined by the main computer to be near or at the current location of user hand 714 (e.g., based on the measured length/distance) and/or the known water pressure associated with a physical version of the showerhead of 3D virtual showerhead 712. The intensity of the heat/air flow of heated air feedback 718 is also determined by the main computer to be near or at the current location of user hand 714 (e.g., based on the measured length/distance). The combination of haptic feedback 722 and heated air feedback 718 on user hand 714 will simulate the sensation of warm water spraying from 3D virtual showerhead 712 and contacting the palm of user hand 714. For example, feedback is caused to be output by mid-air haptic feedback device 702a and mid-air temperature adjustment device 704a, which are both pointing downwards because 3D virtual showerhead 712 is pointing downwards and so it is expected that the user's palm will be facing upwards to contact the warm water flowing downwards out of 3D virtual showerhead 712. In a different example in which water is spraying out upwards from a 3D virtual object (e.g., a water jet in a hot tub), feedback may be caused to be output by mid-air haptic feedback device 702b and mid-air temperature adjustment device 704b, which are both pointing upwards because it is expected that the user's palm will be facing downwards to contact the warm water flowing upwards out of a water jet. In addition to haptic feedback 722 and heated air feedback 718, additional feedback such as, for example, water sounds and/or fragrances may be output by system 700 from appropriate respective feedback devices (not shown) for an immersive simulation experience.

As user hand 714 moves, the focal length and/or pressure of haptic feedback 722 and the heat and/or wind intensity of heated air feedback 718 may be updated by the main computer, accordingly, based on the current location of user hand 714 to better simulate the varying degrees of water pressure and warmth that a user should experience in engaging with the physical version of 3D virtual showerhead 712.

Embodiments of providing a mid-air temperature adjustment output in response to a user input have been disclosed. A user input with respect to a virtual object is detected. At least mid-air temperature adjustment feedback (and sometimes, in addition to mid-air haptic feedback) is provided in response to the detected user input to simulate, for the user, a temperature adjustment (e.g., comprising cold, heat, and/or air flow) being emitted by/from the virtual object so that the user can receive an immersive virtual experience without ever coming in direct contact with a physical object.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a motion detection device configured to detect a user input with respect to a virtual object;
a temperature adjustment device; and
a processor coupled to the motion detection device and the temperature adjustment device, the processor being configured to:
determine a temperature adjustment based at least in part on the user input with respect to the virtual object; and
cause the temperature adjustment device to output the temperature adjustment.

2. The system of claim 1, wherein to determine the temperature adjustment based at least in part on the user input with respect to the virtual object comprises to:
determine a measurement based at least in part on the user input and a reference point associated with the motion detection device;
use the measurement to determine an instruction associated with generating the temperature adjustment; and
send the instruction associated with generating the temperature adjustment to the temperature adjustment device.

3. The system of claim 1, wherein the temperature adjustment device comprises one or more of: a fan a heating component, and a cooling component.

4. The system of claim 3, wherein to cause the temperature adjustment device to output the temperature adjustment comprises to:
send, at a first time, a first instruction to the temperature adjustment device to activate the heating component; and
send, at a second time, a second instruction to the temperature adjustment device to activate the fan, wherein the second time is later than the first time.

5. The system of claim 1, further comprising:
a mid-air haptic feedback device configured to generate a mid-air haptic feedback; and
wherein the processor is coupled to the mid-air haptic feedback device and is further configured to control the mid-air haptic feedback device in response to the user input.

6. The system of claim 5, wherein the mid-air haptic feedback device comprises an ultrasound haptic display configured to emit ultrasound waves to create tactile sensation at one or more focal points using a plurality of transducers.

7. The system of claim 5, wherein to control the mid-air haptic feedback device in response to the user input comprises to:
determine a measurement based at least in part on the user input and a reference point associated with the motion detection device;
use the measurement to determine an instruction associated with generating the mid-air haptic feedback; and
send the instruction associated with generating the mid-air haptic feedback to the mid-air haptic feedback device.

8. The system of claim 5, wherein the processor is configured to control the temperature adjustment device to output the temperature adjustment at least partially simultaneously to the mid-air haptic feedback device outputting the mid-air haptic feedback.

9. The system of claim 1, further comprising:
a display device configured to present the virtual object;
wherein the processor is coupled to the display device and is further configured to determine whether the user input has collided with the virtual object; and
wherein the processor is configured to determine the temperature adjustment based at least in part on the user input with respect to the virtual object based at least in part on whether the user input has collided with the virtual object.

10. The system of claim 9, wherein the display device comprises an autostereoscopic display device.

11. The system of claim 1, wherein the user input is obtained without requiring a user to make a physical contact with a physical object.

12. A method, comprising:
receiving a user input with respect to a virtual object;
updating the virtual object based at least in part on the user input;
determining a temperature adjustment based at least in part on the user input; and
outputting the temperature adjustment.

13. The method of claim 12, wherein the updating the virtual object comprises updating at least one of a shape and animation associated with the virtual object.

14. The method of claim 12, wherein determining the temperature adjustment based at least in part on the user input comprises:
determining a measurement based at least in part on the user input and a reference point; and
using the measurement to determine the temperature adjustment.

15. The method of claim 14, wherein the reference point is associated with a portion of the virtual object.

16. The method of claim 14, wherein the reference point is associated with a location of a motion detection device that detected the user input.

17. The method of claim 12, further comprising:
obtaining information associated with a plurality of virtual objects from an online platform server;
causing the plurality of virtual objects to be presented; and
receiving a selection with respect to a presented virtual object.

18. The method of claim 12, further comprising determining that the user input has collided with a collision area associated with the virtual object.

19. The method of claim 12, wherein the temperature adjustment comprises air flow and at least one of heat adjustment and cold adjustment.

20. The method of claim 12, further comprising:
determining a mid-air haptic feedback based at least in part on the user input; and
outputting the mid-air haptic feedback.
